(19) United States
(12) Patent Application Publication
(10) Pub. No.: US 2004/0088119 A1
(43) Pub. Date: May 6, 2004

(54) System for controlling and monitoring machines and/or systems with active components belonging to different active groups

(76) Inventor: Guenther Landgraf, Karlstadt (DE)

Correspondence Address: Striker Striker & Stenby, 103 East Neck Road, Huntington, NY, 11743, US

(21) Appl. No.: 10/470,430

(22) PCT Filed: Jan. 30, 2002
(86) PCT No.: PCT/DE02/00318

(30) Foreign Application Priority Data
Jan. 30, 2001 (DE) 101 04 163.2

(51) Int. Cl. G01B 5/00

(52) U.S. Cl. 702/33

(57) ABSTRACT

In order to start up and operate a machine/system (2) consisting of interacting active components (3,4) belonging to various action groups (5,6) in a simple and clear manner, a control and monitoring system (1) is provided comprising an especially hierarchically structured instantaneous model (25) of the machine/system (2) with respondable active elements (10,11) corresponding to the actions of various active groups (5,6).

The invention relates to a control and/or monitoring system of machines and/or systems with action components, which in terms of the control/monitoring requirements belong to different action groups (SPS, CNC, drive, MC (motion control), RC (robot control), monitoring, planning, optimization, communications, administration of control media, etc.). Action components can be the following: actuators, such as drives; sensors, detection and/or output elements; or also specific functions for preparation, controlling, monitoring, communication, planning, administration, and optimization of sequences.

Especially in industrial manufacture, machines and/or systems are increasingly used in which sequences of different control/monitoring types have to be executed in a coordinated way. During startup or in the phase of modelling, especially with software, of the machine/system, the sequences are broken down into subsequences, that is, actions to be performed and the transitions (transitional conditions) that are responsible for performing the actions in the correct sequence.

The motions (that is, specific actions) of the drive of a machining tool for workpieces are fundamentally of a different quality from those motions that a robot, for instance, executes to change the tool or to deliver the unmachined workpieces and remove the machined workpieces. In an industrial manufacturing system, these different motions must be coordinated with one another.

To that end, individual actions of the machine/system can be triggered individually, that is, regulated and monitored, via an interface associated with each action. These interfaces are made accessible individually as needed via the control and monitoring system, so that the applicable actions can be monitored and controlled as needed.

The interfaces of different action groups are different, specifically with respect to the programming language used, the transmission protocol, and the transmission routes. The fact that the interfaces are different is also expressed in separate, different kinds of components of the control and monitoring system, as well as the software and the user operation surface.

To coordinate the motions to be executed by different action groups, complicated, tedious startup processes must therefore be performed, which require extensive knowledge of all the components on the part of the operator. Because there are so many different requirements, errors easily occur in the control and monitoring system. Moreover, there is the risk that in coordinating the requisite data/programs, errors of transmission or conversion will occur. As a rule, this affects the entire action of the machine/system, since the industrial manufacturing processes typically proceed sequentially, so that a single error as a rule has an effect on the entire production sequence.

It is therefore the object of the present invention to disclose a control and monitoring system of the type defined at the outset and a machine for controlling machines/systems that on the one hand make it possible practically constantly to obtain a complete overview of the actions/action groups of the machine/system and that at the same time, while preserving the complete overview, allow simple operation of the control and monitoring system, so that on the one hand the control/monitoring is simplified, and the complication and duration of startup and maintenance, and on the other hand the likelihood of transmission or conversion errors in coordinating the various action groups, are minimized.

The invention thus offers the advantage of a complete overview of the instantaneous status of the machine/system; a unitary user operation surface at the same time allows simple, clear startup, operation and monitoring of the machine/system. Because of the unitary nature of the surface and the interfaces involved, errors in transmission/conversion and in the input of control instructions are reduced or even precluded.

It becomes possible, for a control and monitoring system of the type defined at the outset, to disclose a method for startup, visualization, control and monitoring of machines/systems that on the one hand makes it possible to obtain a complete overview practically constantly of all the relevant sequences in the machine/system and at the same time, while preserving the complete overview, to permit reflexive, simple operation of the control and monitoring system, so that on the one hand the control/monitoring is simplified and the complication and duration of startup and maintenance are minimized, and on the other, the likelihood of transmission or conversion errors in coordinating the various action groups is minimized.

This advantage is attained by the instantaneous model, which is brought to display by means of a monitoring, controlling and visualization tool. In particular, it offers a treelike component- and function-oriented view (the instantaneous model need not necessarily contain the component- and function-oriented view/structure) of the existing programs and data, and on the other a status-graph-like view (of the current statuses of the sequences to be controlled and/or monitored, including their actions and transitions). In addition, the tool/instantaneous model makes it possible to influence or vary all the displayed actions and transitions (or their programs and data elements) directly by means of a switchlike function. Thus besides the actual watch mode (status display), a forcing mode (forced setting of transition/action data, such as setting one output for turning on a coolant supply, for instance), or an editing mode (see claim 13) can be established. In the force mode, for instance by targeted setting of a marker, a transition condition can be met and with it the next subsequent action can be performed, while in the editing mode the instantaneous model can be modified; that is, all the data and logic elements on which a transition or transition program or an action or action program is based can be adapted to requirements via the unitary surface, which particularly during the startup of a machine/system makes a universal, simple, direct access to the applicable interface possible. Thus a large part of multiple, complicated, for instance manual, multi-step callups of interfaces for the actions/transitions is dispensed with.

To that end, besides the instantaneous model, status information pertaining to statuses of the action components of different action groups is supplied to a monitoring, control and visualization module/tool for this purpose. If action components are not located in the control and monitoring system, then the associated status information is as a rule delivered via at least one control/feedback line to the monitoring, control and visualization tool.

The action components, besides the actions to be executed, also process the transitions and make their results available, again in the form of status information for the monitoring, control and visualization module. Action components can be actuators, such as drives or input/output devices, hydraulic cylinders, sensors (end switches, photoelectric gates, measurement systems, etc.), that perform the requisite actions, or software functions, which manipulate specific data in a predetermined way or process it or furnish data and information, for instance reading a tool data element.

What is novel is the principle of also modelling sequences of non-SPS-related regions in the same way by means of actions and transitions. Instead of triggering valves, input/output devices, etc., even more-complex CNC, MC or RC motions and/or functions (for instance in interpolating fashion, with couplings to other axes, tool path correction, transformations, etc.) and more-complex logic elements and/or tasks (such as the execution of software routines for monitoring, optimizing, planning, administration or communication with internal and external systems, etc.) can be made available in a higher-level display.

The status information corresponds to the instantaneous status of the applicable action component or components. It is delivered to the instantaneous model and is fed into the monitoring control and visualization module in a user operation and display section of the control and monitoring system and displayed there. Expanded by the input status information, the instantaneous model is updated—preferably constantly, or practically in real time (for instance with regard to a particular operator). In this sense, real time refers to the time constants of the applicable action group; for different action groups and different requirements in terms of updatedness, it is certainly possible for different updating times and cycles to be provided.

For each machine/system, the instantaneous model includes a component- and function-oriented combination of the data and programs, including the actions and transitions required for status-graphlike programming and representation of sequences.

Permanent data are thus taken into account that for a machine/system configuration represent invariable parameters, as well volatile and updated data that represent the status information, for instance. The permanent data—just like the volatile data—may be stored in a memory with random access. However, they can also be a fixed ingredient, that cannot be varied by software, of the control and monitoring system. Preferably, the permanent data, such as drive or CNC control parameters, are variable, however, and are stored in memory in the control and monitoring system, so that for different machines/systems, different models can be created and thus also controlled using one and the same control and monitoring system.

It is preferable for the control and/or monitoring system to have an input interface for control and/or drive and/or monitoring and/or communication and/or planning and/or control media administration and/or optimizing data and/or programs along with means for storing these data/programs in memory; the stored data/programs can be called up in the parametrizing of the action components, by action/transition programs, that is, in particular the definition of peripheral conditions and/or the construction and/or processing of the instantaneous model.

The instantaneous model includes the action elements and transition elements for the status-graphlike visualization and programming; the action elements represent the actions, and the transition elements represent the transitions (that is, transitional conditions between the actions, for instance in the form of an independent program or a program component that—in particular as needed—is executed cyclically). “Actions” means not only physically visible actions but also software actions that are not directly visible, such as modification, monitoring, optimizing, planning or administration of operating data, such as switch positions, machine component positions, the number of tools still usable within a tool store, and so forth. Action programs need not necessarily be associated (via the appropriate interface) with action elements; that is, they may also be empty. This can for instance be the case if certain statuses that are influenced by other actions have to be visualized. Possibly (as in an SFC or sequential function chart under the standard EN 61131-3), action elements can also have the property that besides a one-time machining, they can also be machined cyclically, with a one-time delay, delayed always, always delayed, and so forth. Depending on the application, it may under some circumstances also be desirable for a plurality of action elements to be active within one sequence.

Accordingly, a transition program need not necessarily be assigned to a transition element, as long as the sole condition is that the preceding action (command) has been executed. This is true particularly for sequence-oriented actions, such as the execution of motion commands in a CNC, MC or RC action group. Transitions are processed in the applicable action groups, taking the relevant cycle times there into account. Besides the existing action elements and transition elements, the instantaneous model also represents the physical configuration of the machine/system, preferably with all its components. It is accordingly a machine/system model that can be displayed, configured, and user-operated.

The sequences in a machine/system can as a rule first be assigned to components or subcomponents of the machine/system, or functions or subfunctions, and then modelled hierarchically (from coarse to fine). Accordingly, the instantaneous model for the status-graphlike representation and programming is constructed of linked-together action elements and transition elements over a plurality of levels, with only one action element preferably active in each level. If action elements extend over a plurality of levels, then once again only one action element in each level is active.

The linking of the action elements and transition elements of one or more levels with one another is predetermined by the sequences to be controlled and/or monitored and/or optimized and is programmed and optimized in the course of startup.

The action elements represent the associated actions, including the programs required for them; the transition elements correspond to the transitions and the programs required for them. An action can for instance correspond to a set-point value to be assumed by a component, or a speed or rpm value that is provided. Accordingly, both static and dynamic actions and statuses are provided.

Once the user, using the monitoring control and visualization module, has selected the component/function/subcomponent/subfunction relevant to him within a treelike selection menu, he reaches the status-graphlike display. Updating of the status-graphlike display can be done by visibly marking whichever action element corresponds to the current action element in the applicable level and that is just now being executed in the machine/system, or whose previous transition has been fulfilled at that time. This can be done for instance by emphasizing the applicable action element, or by a sequence pointer that in updated fashion points at the appropriate part of the instantaneous model. The updating can also include the display of current status information or other status information relevant to the particular action or transition, such as positions, speeds, speeds of rotation, or on-off statuses.

Instead of a status-graphlike display, some other representation that represents the actions and transitions can be selected, such as a signal-flowchart-like display that is constructed on the order of a signal flowchart.

What is essential is that the action/transition element and transition elements—preferably all the relevant sequences—of different action groups can each be individually addressed, in particular in the manner of a switch, or in other words newly set up, modified, and viewed, and their data can be varied. For a fixed machine configuration, these can be genuine physical switches. In order to be able to control a machine/system that is configurable, parametrizable and programmable with a plurality of degrees of freedom using a control and monitoring system of the invention, the individual action elements and transition elements, displays, editors, switching fields, etc. can be addressed via input means. These input means can for instance be touch screens, keyboard functions, or panels/touch panels or the like specifically intended for that purpose.

Thus practically any arbitrary machine/system configuration can be completely put into operation, controlled, monitored and visualized by means of a control and monitoring system of the invention.

Preferred features of the present invention are described in further detail below.

With the invention, for the first time it is possible for all the actions to be integrated in a unitary control and monitoring system with a unitary user operation surface (that is, a monitoring, control and visualization tool) in such a way that actions (or the associated action programs) of different action groups can, in unitary fashion, be put into operation, controlled and monitored. These include for instance CNC, RC (robot control), MC (motion control), SPS, drive, monitoring, planning, administration, communication and optimization action groups. In industrial manufacturing technology, SPS action groups are often present, which along with CNC and/or drive action groups have to be integrated and coordinated; even this was impossible until now using a unitary control and monitoring system with unitary operating and visualization surface for these different action groups, and is achieved for the first time by means of the invention. Thus many typically occurring applications in industrial manufacturing technology are already covered by this embodiment of the invention.

The random, constant overview of all the actions of the machine/system makes it especially advantageous if the updating of the instantaneous model is practically instantaneous—from the standpoint of an operator. The requirements for this can readily be met even in complex machines/systems, since the time constants associated with it are relatively long. The updating of the instantaneous model is preferably done at a cycle that is less than or equal to 500 milliseconds, and especially preferably less than or equal to 100 milliseconds. This depends on the requisite updatedness of the particular application. For certain applications, it can certainly suffice if the cycle amounts to from several seconds to approximately 10 minutes. This is the case for instance in such slowly changing processes to be controlled/monitored as inventory control, logistics, etc.

The simulation of the machine/system by the instantaneous model is preferably complete; that is, the instantaneous model includes all the sequences to be controlled of all the components of the machine/system. The components of the machine/system include in particular all the drives, motors and sensors. Thus with the control and monitoring system of the invention and with the aid of the instantaneous model, the entire machine/system can be unitarily put into operation, controlled, monitored, and operated. In particular, all that is demanded of the user/operator is knowledge of how to use a unitary user operation surface.

Even if the instantaneous model is not intended to include all the actions to be controlled for all the components of the machine/system, it is nevertheless unitary, higher-level and universal with regard to different action groups. This means that for at least two different action groups, a single control and monitoring system of the invention with a single instantaneous model can be provided that is unitary in equal fashion for all the intended, different action groups and makes it possible to control and monitor them simultaneously.

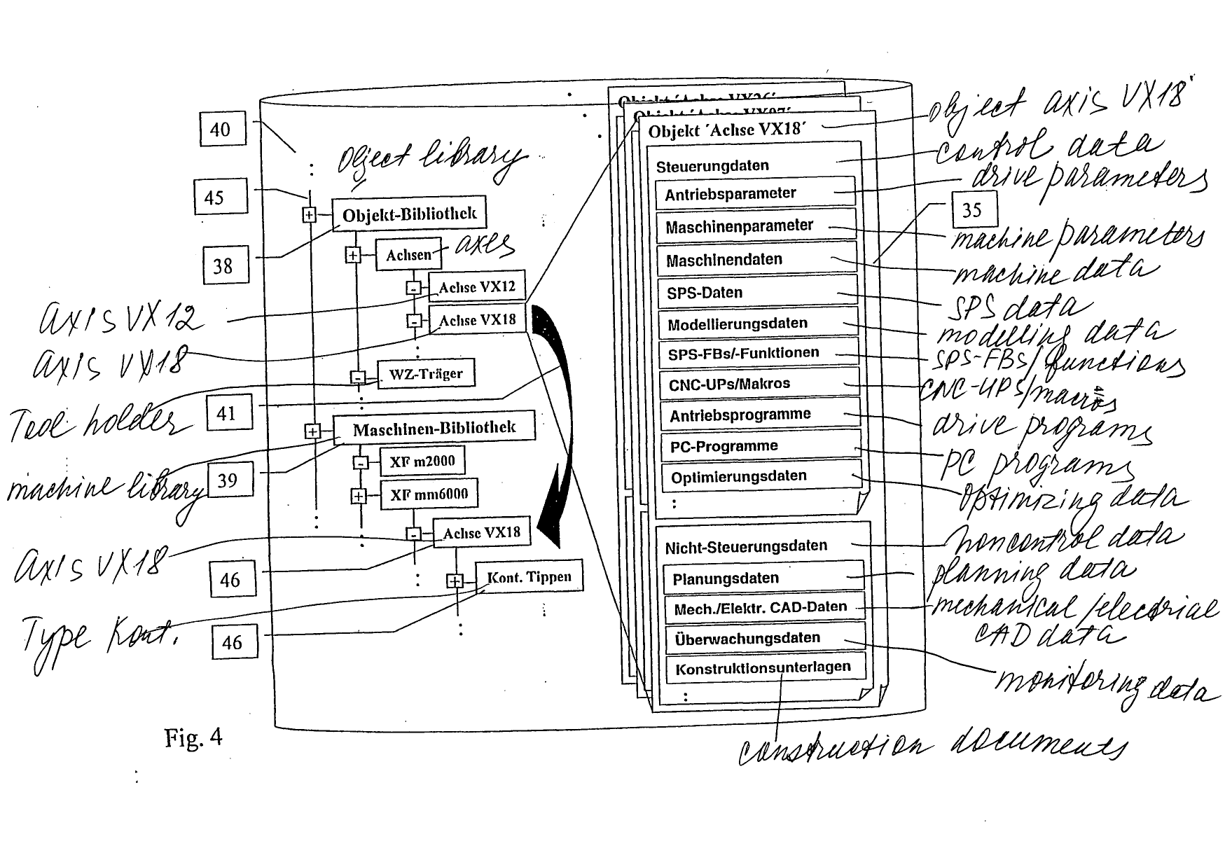

Accordingly, in the control and monitoring system, an object-oriented database model (see below, FIG. 4) with the data recited there is also present. What is novel in this connection is the principle of storing individual objects (components/subcomponents/functions/subfunctions) of the machine/system, with all the relative data, in memory in an object library (as long as they have proved appropriate in practice). By using these objects, it is then possible in a machine library to construct new machines with software or improve or develop existing ones. Thus even entire systems that are composed of a plurality of machines can be taken into account in the instantaneous model.

The actual programming and data/parameter inputs for the individual objects can—as before—be done either at the beginning or during startup by hand, or alternatively by using program generators. The modelling of individual objects (components/functions) and their sequences can be done by means of UML (unified modelling language) or UML-like description means (in particular, profession-oriented expansions) and then converted, by means of program generators—under some circumstances via an intermediate language (such as XML, for extended markup language) for control- or action-group-independent neutral problem description into the specific problem-oriented programming languages of the particular action group, and the programs and data required for the individual objects can be generated.

The part of the above object directed to the method for controlling machines and/or systems with action components is attained by the characteristics of claim 18.

The aforementioned object is already attained by using a control and monitoring system of one of claims 1-17 in a machine/system with cooperating SPS components, that is, such components that are simultaneously present in a machine and that cooperate with one another, with additional CNC and/or drive components that cooperate with them. The advantages of the invention are then already obtained because of the fact that the otherwise incompatible SPS and additional CNC/drive components, in terms of software, hardware, and the transmission protocol, are integrated in a unitary user operation surface that at the same and in unitary fashion permits the operation, visualization, and in particular the startup of a machine/system. The operation is intuitive, since the instantaneous model used simulates the machine/system functionally in a manner true to nature.

The invention will be described in further detail in terms of exemplary embodiments shown in the drawings. Shown are:

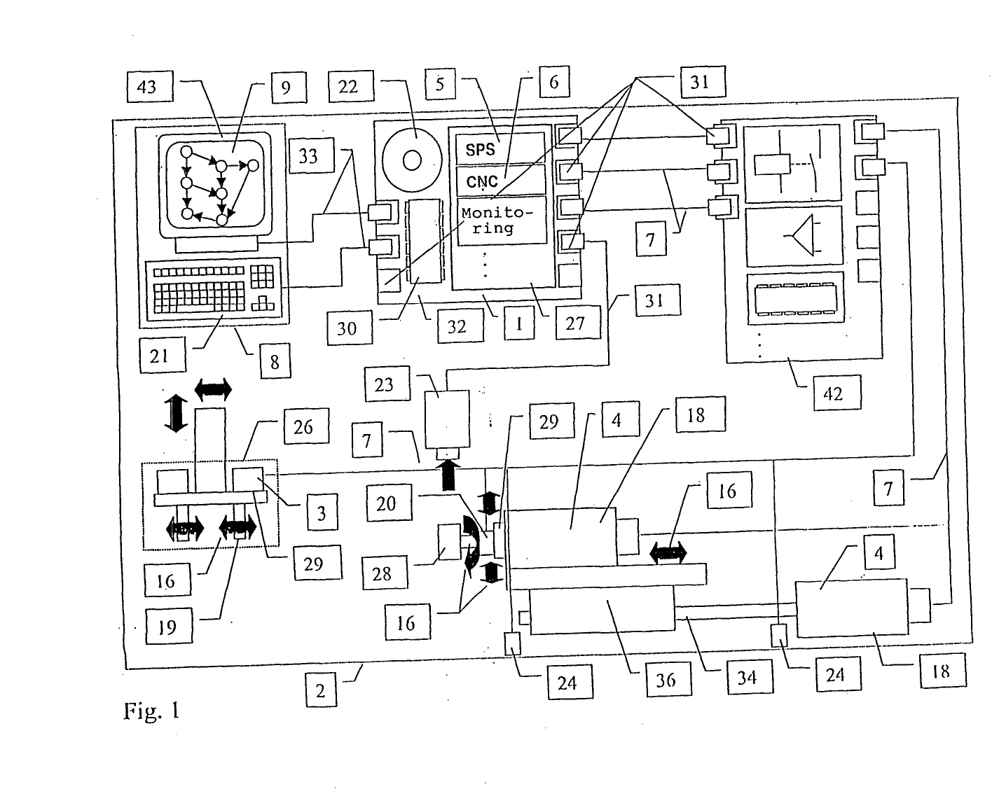

FIG. 1, a schematic drawing of a control and monitoring system of the invention, in a machine with cooperating action elements of different action groups;

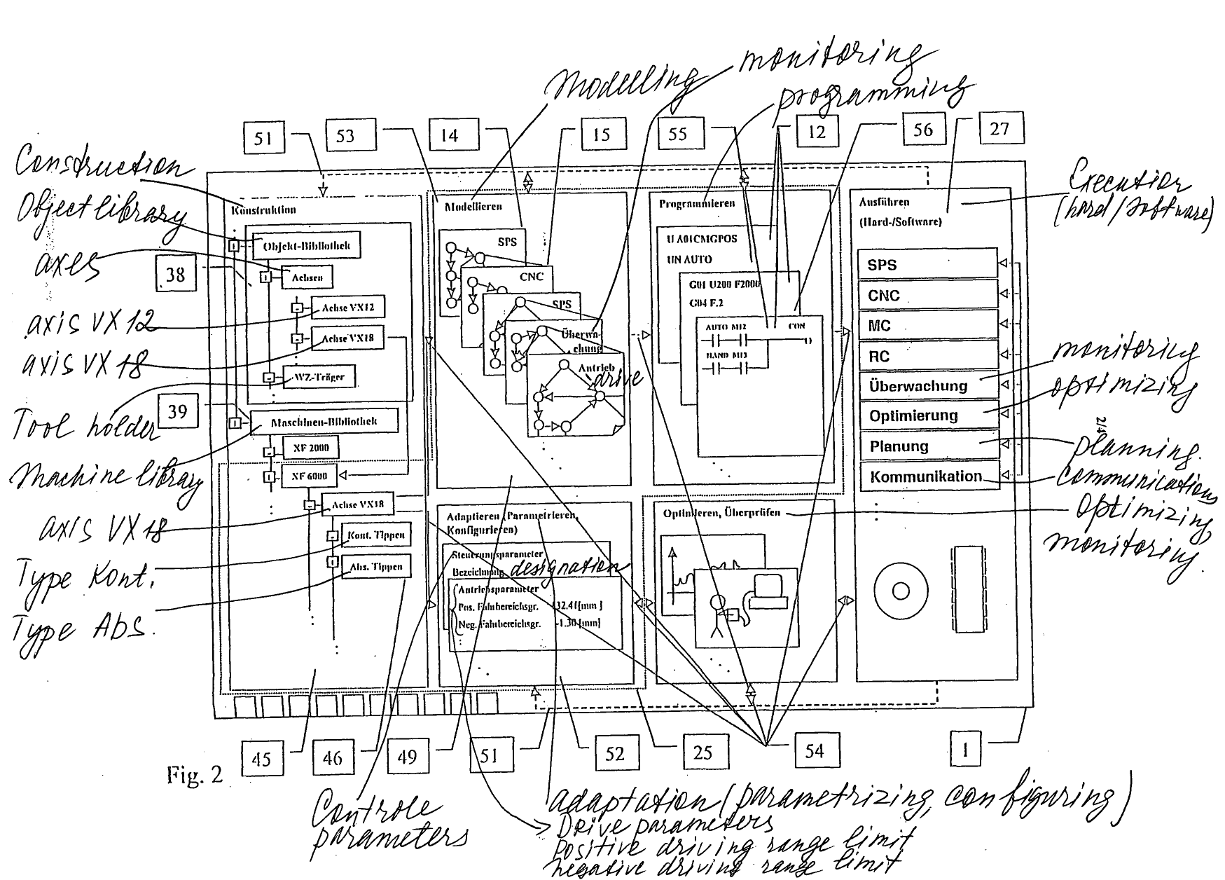

FIG. 2, a schematic overview of the instantaneous model, some action groups of the control and monitoring system, and the most-important program and data flows;

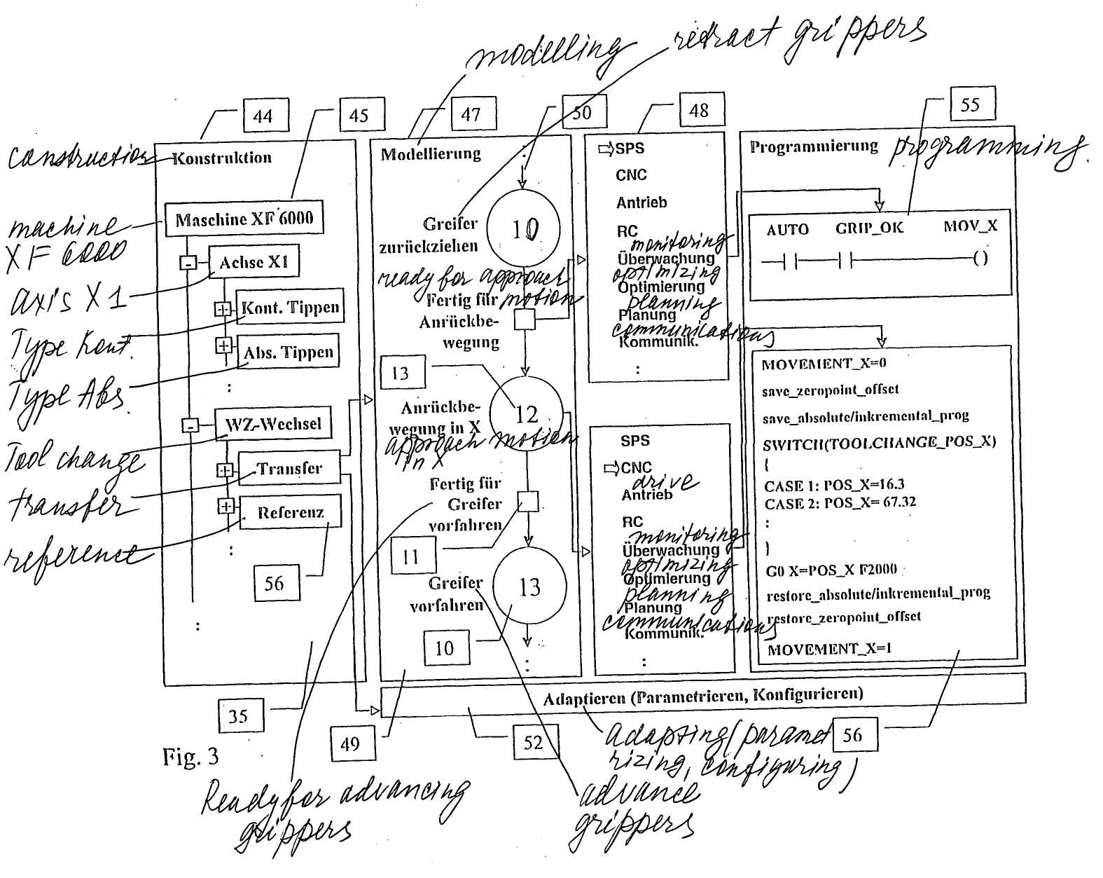

FIG. 3, a detail of a model of a tool changing operation to be controlled; and

FIG. 4, the basic structure of a database, with all the data required for the production and in particular startup and operation of a machine/system.

Unless otherwise noted below, all the reference numerals always apply to all the drawings.

FIG. 1 shows a control and/or monitoring system (1) in a machine/system (2) schematically. For the sake of simplicity, this will simply be called system (2) hereinafter.

The system (2) has action components (3, 4), which belong to different action groups (5, 6, 27). The system (2) is an automated industrial manufacturing system in which a workpiece (not shown here) is machined. For the machining, different tools (28) are needed. These tools are furnished in a tool magazine (not shown). A tool no longer needed for further processing of the workpiece is automatically, after its further usability has been monitored by means of a sensor (23), removed from the tool receptacle (20) toward the spindle, using a handling system (not shown) with a gripper (26) and placed in a tool magazine, and then another tool, required for the further machining and still usable, is taken from the magazine and placed in the tool receptacle (20) toward the spindle.

The sequence mentioned is an automation sequence, in which frequently recurring actions (16) are performed. Besides strict adherence to an order (in particular a predetermined order) in which the individual actions are to be performed, proper execution of the individual actions is especially critical. If even only a single action might possibly not be performed properly, then the next following actions cannot be performed either, since otherwise damage to the tool, workpiece, or system or even harm to human beings can occur. Moreover, in modern manufacturing systems, a chronologically optimal overall sequence is primary, that is, an optimal interplay of the SPS and CNC action elements.

The actions (16) to be performed for supplying and removing tools from the tool receptacle (20) toward the spindle are schematically represented by double arrows; these mean that the gripper (26) (or its CNC action components called “drives” (18) that move it) is moved linearly, or under some circumstances even with circular interpolation, in the direction indicated; that the gripper jaws (19) (or their SPS action component called “hydraulic cylinder” (24)) for gripping the tools are moved together and apart again for separation, the tool carriage (36) (or its CNC action component called a “drive” (18)) is put in the requisite position for changing; the tool receptacle (20) toward the spindle (or the SPS action component “tool chuck” (not shown)) is opened for the removal of tools and closed again to receive a tool; the tool spindle (29) (or its CNC action component “drive” (18)), to begin a tool change, discontinues its rotary motion and assumes the requisite position; and the sensor (23) (or its monitoring action component, not shown, called “monitor tool”) inspects the tool.

The actual machining unit comprises the tool carriage (36) with the corresponding drive (18) for moving the carriage. In addition, there is a further drive (18), which drives the tool spindle (29). Both the tool carriage and the tool spindle (29), with their drives, are assigned to the action group CNC (6); the action group CNC (6) can also be influenced in its behavior by the action group SPS (5). This can be the case for instance when the tool carriage (36) leaves the permitted driving range and in so doing actuates the end switches (24). The action group SPS (5) thereupon withdraws the freedom of motion from the action component CNC (6), whereupon the latter stops the applicable axes as fast as possible. This process of driving range monitoring can also be achieved very simply by means of the above-described action/transition elements (and the associated programs).

The control and monitoring system (1) shown schematically here comprises control logic components (30) and storage means (22). Besides these components that are present in the control electronics (32), the action groups (27) (SPS (3), CNC (4), MC, RC, monitoring, planning, optimizing, communications, control media administration, etc.) and a user operation and display section (8) are all provided, the latter communicating with the control electronics (32) over data lines (33). The user operation and display section (8) has a display (43) and an input interface (21). In the display (8), the monitoring, control and visualization module (9) of the invention comes into use, by employing the instantaneous model (25).

Between the action groups (5, 6) and the action elements (10) assigned to them, amplifier/converters (42) are used, such as drive amplifiers, input/output devices, hydraulics units, etc. Besides the actual control and monitoring system (1), these devices can also include additional action groups (27), such as extensive functionality within a drive amplifier, examples being measurement functions, electronic cam functions, etc.

FIG. 2 shows a schematic illustration of the instantaneous model (25), represented by the data/modules shown symbolically as a menu, various action groups (27) of a control and monitoring system (1), and the essential program and data flows (54). For controlling the action components (3, 4) both inside and outside the control and monitoring system, the action groups (27) communicate via the usual data exchange mechanisms/interfaces (12) (such as shared memory, dual ported RAM), protocols (such as RS 232, SERCOS interface) and callup mechanisms (such as interrupt-controlled multitasking). The same is correspondingly true for furnishing the data required within the transition/action programs (55, 56) that are not present within the applicable action group (27). Since the transitions (17) (that is, programs for monitoring a transition condition) must be monitored cyclically as to their status, the data not available in the applicable action group (27) must also be furnished cyclically there. The same is true for the further transmission of results of transitions (or transition programs) (55), if they are needed in other action groups (27). Action groups (27) that do not have any cyclical processing capability (such as older CNCs), but also performance reasons or reasons of simplicity can mean that transition programs (55) that belong to one action group must be executed by other action groups (27) (preferably by the SPS). In such cases, once a transition (17) has been fulfilled, the associated action (16) or action program (56) can be brought to execution (for instance by means of interrupt-like mechanisms, such as interrupt-controlled callup of an NC subroutine).

The instantaneous model (25) is object-oriented in construction and is dependent on the physical configuration of the machine/system (2). Relevant objects of the instantaneous model (25) are the individual components and subcomponents of the machine/system (35) and the functions and subfunctions (45) (which as a rule are assigned to the individual components/subcomponents). The object-oriented structure of the instantaneous model (25) is thus equivalent to the component-/function-oriented construction of the machine/system (2).

Within the structural tree, the user can assign each object its relevant data that remain there afterward as well, for instance when the instantaneous model (25) or individual objects is being secured or copied.

This novel principle makes it possible not only for data relevant to the control and monitoring system but also other supplementary data, which fundamentally facilitate later operation of the machine, improvements to the machine, or new procurement to be entrained. Such supplementary data can for instance be order documents, construction and manufacturing drawings, cabling layout, oscillation analyses for certain machine parts, cycle times of the machines, data for maintenance intervals, data for analyzing weak points, or data for machine optimization.

The drawing predominantly shows the control-relevant data, that is, in particular the data (52) that enable adaptation of the control and monitoring system (1) to the existing control and monitoring system (1), and the data and programs, including the action group-oriented programs and data (16, 17), required for the status-graphlike programming. It must be noted that the sequences can extend over a plurality of levels (14, 15); that is, on another level an action is more finely detailed into further actions and transitions. This can be accomplished for instance by providing that the applicable action element/program triggers a transition element/program in a subordinate level, or calls up a group (that is, a new level) of action elements in the form of a macro or subroutine.

FIG. 3, in a detail of a tool change sequence (in which action elements of the CNC and of the SPS are involved), shows the work steps required for the user, and the menus to be gone through.

During the startup, the user proceeds as follows: First, in the construction menu (44), he inputs his components/functions (48) that are relative to the system into the treelike component- and function-oriented structure (45). After that, in the modelling menu (47), he models the sequences (50) pertaining to the applicable component or structure, by entering the relevant action elements (10) and transition elements (11)—if necessary, proceeding over a plurality of levels from coarse to fine. Once the relevant action elements (10, 11) have been set up, the user programs the associated action/transition programs. To that end, for each action/transition (16), he selects that action group (48) in which the associated programs are to be executed. In the selection menus, preferably only those action groups that are also available within the machine/system should be displayed for selection. Moreover, action groups (27) that have no cyclical program processing mechanisms should not be included in the selection of the action group for a transition.

In the selection, the user should also take into account the fact that action programs (56) can be programmed only in the action groups (27) in which the requisite infrastructure for the applicable actions (16) is available; for instance, the desired problem-oriented language (ISO 6983 with specific expansions, ISO 14649, EN 61131-3 (AWL, SFC, LD, FBD, ST), C, C++, Visual Basic, HTML, XML, etc.) are available and the action components (3, 4) to be addressed within the action programs (56) are present in the applicable action group (27) or can be addressed from there.

Transitions should in general be executed in the action group (27) in which the majority of data required within the transition programs (55) is also available, if cyclical processing of the transition conditions is present there. However, transition programs (55) can also be executed preferentially or completely in only a single action group (preferably in the SPS). For example, program lines of a CNC action program (56) with sophisticated speech elements and an SPS transition program (57) on the order of a flowchart are shown within the picture, for instance.

Besides the action/transition programming (55, 56) with the programming language optimized for the particular problem involved and the requisite development environments/interfaces (12) (editors, compilers, linkers, transmission mechanisms, etc.), machine data and parameter data (52) for adapting the control and monitoring system, the action groups, and individual objects (components/functions) (46) must also be specified to the machines/systems. The integration of the various development environments especially the visual part—into the monitoring control and visualization tool is done by using currently usual mechanisms, such as COM or Active-X.

FIG. 4 shows a more-detailed, schematic illustration of the database module (40). The database module (40) is constructed hierarchically in the manner of a tree (45); the database module (40) is subdivided into two essential regions: the actual object library (38), with all the objects (46) already used in machines/systems (and hence that have passed the test of time as a rule), components/functions (56), and on the other, the machine library (39), which is constructed from the objects (46) of the object library (38).

The individual objects (46) represent the individual components/subcomponents (46) of the machine/system or functions/subfunctions (46) of the machine/system, or individual components/subcomponents. In accordance with requirements, control-/monitoring-relevant information corresponding to requirements but also additional information (as described above) can be assigned to the individual objects (46). For different machines/systems, sometimes even different objects (46) with virtually arbitrary data are present within the database module. As a result—depending on the application—different and preferably all possible configurations for all physically possible applications of a machine/system (2) can be assembled. As shown in FIG. 4, the data of the database module (40) are used for adapting the monitoring and control system (1) or its action groups (27). However, in particular they can be used for constructing and processing the data required for the status-graphlike display, including the action/transition elements (10, 11) and action/transition programs (55, 56). The data can be the following: control-relevant data (such as drive parameters, machine parameters, machine data, SPS data, modelling data, SPS functions and SPS function modules, CNC subroutines and macros, drive programs, PC programs, administration programs, communications programs, and optimization programs), or noncontrol data (supplementary data, such as planning data, mechanical and electrical construction drawings, and monitoring data).

### List of Reference Numerals

1 Control and monitoring system

2 Machine/system

3 Action components of an SPS action group (e.g., input/output device or hydraulic cylinder)

4 Action components of a CNC action group (e.g., drive mechanism)

5 SPS action group

6 CNC action group

7 Control/feedback line (e.g., drive bus or field bus)

8 User operation and display section

9 Monitoring, control and visualization tool

10 Action element

11 Transition element

12 Control and/or monitoring interface

13 Active action element

14 Hierarchical level

15 Adjacent hierarchical level

16 Action

17 Transition

18 Drive

19 Gripper jaws

20 Tool receptacle (toward spindle)

21 Input interface

22 Memory means

23 Sensor (such as CCD camera)

24 End switch

25 Instantaneous model

26 Gripper

27 Action groups

28 Tool

29 Tool spindle

30 Control logic module

31 Connection/interface

32 Control electronics

33 Data line

34 Ball roll spindle

35 Component-/function-oriented combining of data and programs

36 Tool carriage

37 Hydraulic cylinder

38 Object library

39 Machine library

40 Data base module (object data base)

41 Software-based construction by means of objects (components/functions)

42 Amplifiers/converters (e.g., drive amplifies, input/out unit, hydraulic assembly, etc.)

43 Display

44 Construction menu

45 Treelike component- and function-oriented view/structure

46 Objects (components/functions)

47 Modeling menu

48 Selection of the action group

49 Status-graphlike view/structure

50 Sequence

51 Status information

52 Parameter data for adapting the control and monitoring system to the machine/system

53 Data for statuslike programming and visualization

Program and data flow

Transition program

Action program

1. A system (1) for controlling and/or monitoring machines and/or systems (2) with action components (3, 4) that in terms of the control/monitoring requirements belong to different action groups (5, 6), wherein the control and/or monitoring system (1) is supplied with status information (51) pertaining to action components (3, 4) of different action groups (5, 6), which information corresponds to the instantaneous status of associated action components (3, 4) and is fed into a user operation and display section (8) with a displayed instantaneous model (25) of the machine/system (2) and processed for updating the instantaneous model (25), which model is constructed, on the specification of the physical configuration of the machine/system (2), of linked-together action elements (10) and transition elements (11), of which action/transition elements (10, 11), different action groups (5, 6) can be addressed individually and upon being addressed trigger a control and monitoring interface (12) of the applicable action (16)/transition (17), in particular of action/transition programs (5, 6), or call up other action/transition elements (10, 11).

2. The control and/or monitoring system of claim 1, characterized in that the instantaneous model (25), for each machine/system, includes a component- and function-oriented combination of data and programs (35), including the action/transition programs (55, 56) required for the status-graphlike programming and representation (49) of sequences, and the data of these programs.

3. The control and/or monitoring system of claim 1 or 2, characterized in that via at least one feedback line (7), status information signals (51) pertaining to action components (3, 4) of different action groups (5, 6) are delivered to the control and monitoring system (1).

4. The control and monitoring system of one of claims 1-3, characterized in that action elements (10) are linked together by transition elements (11), or correspond to transitions (17) to be performed between the corresponding actions (16).

5. The control and monitoring system of one of claims 1-4, characterized in that the action groups (5, 6, 27) are CNC and/or RC and/or MC and/or SPS and/or drive and/or monitoring and/or optimizing and/or communication and/or administration and/or planning action groups.

6. The control and monitoring system of claim 5, characterized in that the machine/system (2) has SPS action groups (5) and additionally has CNC (6) and/or drive action groups.

7. The control and monitoring system of claim 6, characterized in that CNC action components (4) of an SPS action group (5), in particular of programs belonging to it, can be influenced, in particular interrupted, addressed or controlled, for the current CNC machining by means of interrupt-controlled mechanisms, in particular an asynchronous subroutine callup.

8. The control and monitoring system of one of claims 1-7, characterized in that action/transition elements (10, 11) are combined into levels (14, 15) in the instantaneous model (25), and all the action/transition elements (10, 11) of one level (14, 15) belong to only a single action group (5, 6, 27).

9. The control and monitoring system of one of claims 1-8, characterized in that the updating is done at a cycle that is less than or equal to 500 milliseconds, preferably less than or equal to 100 milliseconds.

10. The control and monitoring system of one of claims 1-9, characterized in that the instantaneous model (25) includes essentially all the actions (16) to be controlled for all the components (19, 20) of the machine/system (2).

11. The control and monitoring system of one of claims 1-10, characterized in that with regard to different action groups (5, 6), it is unitary, higher-level and universal.

12. The control and monitoring system of one of claims 1-11, characterized in that it has an input interface (21) for control and/or drive and/or monitoring and/or communication and/or optimizing data and/or programs as well as means (22) for readout of these data/programs, and the data/programs stored in memory can be called up in the parametrizing of the control/monitoring system and/or of the actions/transitions, in particular the definition of peripheral conditions, and/or construction and/or processing of the instantaneous model (25).

13. The control and monitoring system of one of claims 1-12, characterized in that in the control and/or monitoring system (1), in particular in an operating tool present in it, a switchover can be made between a watch mode for status display, a force mode for forced setting of transition/action data, and an editing mode for editing the transition/action programs.

14. The control and monitoring system of one of claims 1-13, characterized in that in the control and monitoring system (1), there is an object-oriented database module (45) with an object library (38) and a machine library (39), and by using the machine library (39), individual objects (46) (components/subcomponents/functions/subfunctions) of the machine/system (2) come with all the relative data, can be set up, tested and stored in memory, and by using the object library (38), by means of objects (46) stored in memory, new machines/objects (46) can be constructed or modelled, or existing machines and/or objects (46) can be processed, improved, or further developed and stored in memory.

15. The control and monitoring system of one of claims 1-14, characterized in that the programs (55, 56) and data required for an instantaneous model (25) of individual components/subcomponents/functions/subfunctions can be set up by hand or by using program generators, in particular after the selection of a suitable interface (12) by means of the instantaneous model (25).

16. The control and monitoring system of one of claims 1-15, characterized in that the instantaneous model (25) is subdivided into levels (14, 15) on the specification of the physical configuration of the machine/system (2).

17. The control and monitoring system of claim 16, characterized in that certain actions (16) and transitions (17) form common sequences that extend over a plurality of levels (14, 15), corresponding to them, in the instantaneous model (25), and an action element (10) can call up a further level (15) with action elements (10) and transition elements (11), in particular in the form of a subroutine/macro.

18. A method for controlling and/or monitoring machines and/or systems (2) with action components (3, 4), in particular with a control and monitoring system (1) of one of claims 1-10, in which the action components (3, 4) belong to different action groups (5, 6) in terms of the control requirements, and status information (51) pertaining to action components (3, 4) of different action groups (5, 6) are supplied to the control and monitoring system (1), which information corresponds to the instantaneous status of the applicable action components (3, 4) and is incorporated into an instantaneous model (25) of the machine/system (2), which model, on the specification of the physical configuration of the machine/system (2), comprises linked-together action elements (10) and transition elements (11), and which is displayed and rendered operable in such a way that action elements (10, 11) of different action groups (5, 6) can be addressed individually, and upon the addressing, a control and monitoring interface (12) of the associated action/transition, in particular of action/transition programs (55, 56), is triggered, or action elements (10) of an adjacent level (14, 15) are displayed in addressable form.

19. The use of a control and monitoring system of one of claims 1-10 in a machine/system (2) with cooperating SPS (3) and/or CNC (4) and/or drive components.
